(19) United States
(12) Patent Application Publication
(10) Pub. No.: US 2024/0251430 A1
(43) Pub. Date: Jul. 25, 2024

(54) RSRP-BASED CONFLICT INDICATION FOR SIDELINK INTER-UE COORDINATION

(71) Applicant: QUALCOMM INCORPORATED, San Diego, CA (US)

(72) Inventors: Shuanshuan Wu, San Diego, CA (US); Tien Viet Nguyen, Bridgewater, NJ (US); Gabi Sarkis, San Diego, CA (US); Sourjya Dutta, San Diego, CA (US); Kapil Gulati, Belle Mead, NJ (US); Hui Guo, Beijing (CN)

(21) Appl. No.: 18/560,645

(22) PCT Filed: Jul. 22, 2021
(86) PCT No.: PCT/CN2021/107827

§ 371 Date: Nov. 13, 2023

(51) Int. Cl. H04W 72/25; H04W 72/044; H04W 72/566

(52) U.S. Cl. CPC H04W 72/25; H04W 72/0473; H04W 72/566

(57) ABSTRACT

Methods, systems, and devices for wireless communications are described. A user equipment (UE) may receive a first sidelink control information (SCI) from a second UE and a second SCI from a third CE, the first SCI may indicate a first set of resources and the second SCI may indicate a second set of resources that at least partially overlap with the first set of resources. The sets of resources may indicate resources reserved by the UEs for sidelink communications. The first UE may measure a first received power associated with the second UE or a second received power associated with the third UE, or both, based on the overlap and may transmit, to the second UE and/or the third UE, an indication of a conflict based on the first received power and/or the second received power satisfying a condition.

### CROSS REFERENCE

The present Application is a 371 national stage filing of International PCT Application No. PCT/CN2021/107827 by INVENTOR et al. entitled “RSRP-BASED CONFLICT INDICATION FOR SIDELINK INTER-UE COORDINATION,” filed Jul. 22, 2021, which is assigned to the assignee hereof, and which is expressly incorporated by reference in its entirety herein.

### FIELD OF TECHNOLOGY

The following relates to wireless communications, including reference signal received power (RSRP)-based conflict indication for sidelink inter-user equipment (UE) coordination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some UEs, such as a vehicle UE configured for vehicle-to-everything (V2X) communications, may be configured to communicate with other UEs according to an autonomous resource selection procedure. For example, some UEs may select resources for transmitting sidelink communications independent of a resource allocation procedure with a base station or other network entity. In such cases, two UEs may select the same resources, causing a conflict or collision (e.g., a past or potential conflict or collision) between transmissions.

### SUMMARY

The described techniques relate to improved methods, systems, devices, and apparatuses that support reference signal received power (RSRP)-based conflict indication for sidelink inter-user equipment (UE) coordination. Generally, the described techniques provide for a non-conflicting (e.g., a non-colliding or a helping) UE to indicate a scheduling conflict via an inter-UE coordination message. For example, when two UEs reserve or transmit on the same or at least partially overlapping resources, a helping UE may transmit an inter-UE coordination message to either or both of the conflicting UEs to indicate the collision. Based on receiving the indication, one or both of the conflicting UEs may take measures such as reselection of resources to avoid the collision, or retransmission of the signaling to increase the likelihood that the signaling will be received by the intended recipient. The helping UE may decide whether to transmit an indication of the conflict, and to which conflicting UE to transmit the indication, based on a power measurement of a reference signal received from either or both of the conflicting UEs. For example, the helping UE may measure a received power from a first UE and a second UE which have scheduled at least partially overlapping resources. The helping UE may determine whether to transmit a conflict indication based on a first received power measurement for the first UE or a second received power measurement for the second UE, or both, satisfying a threshold. The helping UE may transmit the indication of the conflict to the first UE or the second UE, or both. The helping UE may determine the recipient based on the received power measurements or priority of the sidelink signaling, or both.

A method for wireless communications at a first UE is described. The method may include receiving a first sidelink control information (SCI) from a second UE and a second SCI from a third UE, the first SCI indicating a first set of resources and the second SCI indicating a second set of resources that at least partially overlap with the first set of resources, measuring a first received power associated with the second UE or a second received power associated with the third UE, or both, based on the second set of resources partially overlapping with the first set of resources, and transmitting, to the second UE or the third UE, or both, an indication of a conflict based on the first received power or the second received power or both, satisfying a condition.

An apparatus for wireless communications at a first UE is described. The apparatus may include a processor, memory coupled with the processor, and instructions stored in the memory. The instructions may be executable by the processor to cause the apparatus to receive a first SCI from a second UE and a second SCI from a third UE, the first SCI indicating a first set of resources and the second SCI indicating a second set of resources that at least partially overlap with the first set of resources, measure a first received power associated with the second UE or a second received power associated with the third UE, or both, based on the second set of resources partially overlapping with the first set of resources, and transmit, to the second UE or the third UE, or both, an indication of a conflict based on the first received power or the second received power or both, satisfying a condition.

Another apparatus for wireless communications at a first UE is described. The apparatus may include means for receiving a first SCI from a second UE and a second SCI from a third UE, the first SCI indicating a first set of resources and the second SCI indicating a second set of resources that at least partially overlap with the first set of resources, means for measuring a first received power associated with the second UE or a second received power associated with the third UE, or both, based on the second set of resources partially overlapping with the first set of resources, and means for transmitting, to the second UE or the third UE, or both, an indication of a conflict based on the first received power or the second received power or both, satisfying a condition.

A non-transitory computer-readable medium storing code for wireless communications at a first UE is described. The code may include instructions executable by a processor to receive a first SCI from a second UE and a second SCI from a third UE, the first SCI indicating a first set of resources and the second SCI indicating a second set of resources that at least partially overlap with the first set of resources, measure a first received power associated with the second UE or a second received power associated with the third UE, or both, based on the second set of resources partially overlapping with the first set of resources, and transmit, to the second UE or the third UE, or both, an indication of a conflict based on the first received power or the second received power or both, satisfying a condition.

In some examples of the method, apparatuses, and non-transitory computer-readable medium described herein, the condition may be based on a power threshold and the method, apparatuses, and non-transitory computer-readable medium may include further operations, features, means, or instructions for receiving the power threshold from a network entity, receiving the power threshold via the first SCI or the second SCI, or both, and determining the power threshold based on a configuration of the first UE.

In some examples of the method, apparatuses, and non-transitory computer-readable medium described herein, the measuring may include operations, features, means, or instructions for measuring the first received power associated with the second UE and measuring the second received power associated with the third UE.

Some examples of the method, apparatuses, and non-transitory computer-readable medium described herein may further include operations, features, means, or instructions for determining the condition may be satisfied based on the first received power exceeding a power threshold or the second received power exceeding the power threshold, or both.

Some examples of the method, apparatuses, and non-transitory computer-readable medium described herein may further include operations, features, means, or instructions for determining the condition may be satisfied based on the first received power being less than a power threshold or the second received power being less than the power threshold, or both.

In some examples of the method, apparatuses, and non-transitory computer-readable medium described herein, the condition may be based on a first power threshold and a second power threshold that may be greater than the first power threshold and the method, apparatuses, and non-transitory computer-readable medium may include further operations, features, means, or instructions for receiving the first power threshold or the second power threshold, or both, from a network entity, receiving the first power threshold or the second power threshold, or both, via the first SCI or the second SCI, or both, and determining the first power threshold or the second power threshold, or both, based on a configuration of the first UE.

Some examples of the method, apparatuses, and non-transitory computer-readable medium described herein may further include operations, features, means, or instructions for determining the condition may be satisfied based on the first received power or the second received power, or both, being greater than the first power threshold and less than the second power threshold.

In some examples of the method, apparatuses, and non-transitory computer-readable medium described herein, the condition to transmit the indication of the conflict may be based at least on in part on a first priority associated with the second UE or a second priority associated with the third UE.

In some examples of the method, apparatuses, and non-transitory computer-readable medium described herein, the condition may be further based on a priority threshold and the method, apparatuses, and non-transitory computer-readable medium may include further operations, features, means, or instructions for receiving the priority threshold from a network entity, receiving the priority threshold via the first SCI or the second SCI, or both, and determining the priority threshold based on a configuration of the first UE.

In some examples of the method, apparatuses, and non-transitory computer-readable medium described herein, transmitting the indication of the conflict may include operations, features, means, or instructions for transmitting the indication of the conflict based on a first priority of the second UE satisfying the priority threshold or a second priority of the third UE satisfying the priority threshold, or both.

In some examples of the method, apparatuses, and non-transitory computer-readable medium described herein, the first SCI or the second SCI includes a request for the indication of the conflict, and the indication of the conflict may be transmitted based on the request.

In some examples of the method, apparatuses, and non-transitory computer-readable medium described herein, transmitting the indication of the conflict may include operations, features, means, or instructions for transmitting the indication of the conflict to the second UE and the third UE.

In some examples of the method, apparatuses, and non-transitory computer-readable medium described herein, transmitting the indication of the conflict may include operations, features, means, or instructions for transmitting the indication of the conflict to the second UE based on the first received power being greater than the second received power.

In some examples of the method, apparatuses, and non-transitory computer-readable medium described herein, transmitting the indication of the conflict may include operations, features, means, or instructions for transmitting the indication of the conflict to the second UE based on the first received power being less than the second received power.

In some examples of the method, apparatuses, and non-transitory computer-readable medium described herein, the first SCI includes a first indication of a first priority associated with the second UE and the second SCI includes a second indication of a second priority associated with the third UE.

In some examples of the method, apparatuses, and non-transitory computer-readable medium described herein, transmitting the indication of the conflict may include operations, features, means, or instructions for transmitting the indication of the conflict to the second UE based on the first priority associated with the second UE being greater than the second priority associated with the third UE.

In some examples of the method, apparatuses, and non-transitory computer-readable medium described herein, transmitting the indication of the conflict may include operations, features, means, or instructions for transmitting the indication of the conflict to the second UE after the conflict may have occurred based on the first priority associated with the second UE being greater than the second priority associated with the third UE.

In some examples of the method, apparatuses, and non-transitory computer-readable medium described herein, transmitting the indication of the conflict may include operations, features, means, or instructions for transmitting the indication of the conflict to the second UE based on the first priority associated with the second UE being less than the second priority associated with the third UE.

In some examples of the method, apparatuses, and non-transitory computer-readable medium described herein, transmitting the indication of the conflict may include operations, features, means, or instructions for transmitting the indication of the conflict to the second UE prior to the conflict occurring based on the first priority associated with the second UE being less than the second priority associated with the third UE.

In some examples of the method, apparatuses, and non-transitory computer-readable medium described herein, transmitting the indication of the conflict may include operations, features, means, or instructions for transmitting the indication of the conflict to the second UE or the third UE based on the first priority being equal to the second priority.

In some examples of the method, apparatuses, and non-transitory computer-readable medium described herein, transmitting the indication of the conflict may include operations, features, means, or instructions for transmitting the indication of the conflict to the second UE or the third UE based on the first priority associated with the second UE being equal to the second priority associated with the third UE and the first received power being greater than the second received power.

Some examples of the method, apparatuses, and non-transitory computer-readable medium described herein may further include operations, features, means, or instructions for selecting the second UE to receive the indication of the conflict prior to measuring the first received power based on a priority associated with the second UE, where the indication of the conflict may be transmitted to the second UE based at least may be part on the selecting.

In some examples of the method, apparatuses, and non-transitory computer-readable medium described herein, measuring the first received power may include operations, features, means, or instructions for measuring the first received power associated with the second UE based on selecting the second UE to receive the indication of the conflict, where the indication of the conflict may be transmitted to the second UE based on the first received power satisfying the condition.

A method for wireless communications at a second UE is described. The method may include transmitting, to a first UE, SCI indicating a first set of resources for a sidelink transmission, receiving, from the first UE, an indication of a conflict between the first set of resources and a second set of resources associated with a third UE based on a first measured power associated with the first UE or a second measure power associated with the second UE, or both, satisfying a condition, and transmitting the sidelink transmission using a third set of resources different from the first set of resources.

An apparatus for wireless communications at a second UE is described. The apparatus may include a processor, memory coupled with the processor, and instructions stored in the memory. The instructions may be executable by the processor to cause the apparatus to transmit, to a first UE, SCI indicating a first set of resources for a sidelink transmission, receive, from the first UE, an indication of a conflict between the first set of resources and a second set of resources associated with a third UE based on a first measured power associated with the first UE or a second measure power associated with the second UE, or both, satisfying a condition, and transmit the sidelink transmission using a third set of resources different from the first set of resources.

Another apparatus for wireless communications at a second UE is described. The apparatus may include means for transmitting, to a first UE, SCI indicating a first set of resources for a sidelink transmission, means for receiving, from the first UE, an indication of a conflict between the first set of resources and a second set of resources associated with a third UE based on a first measured power associated with the first UE or a second measure power associated with the second UE, or both, satisfying a condition, and means for transmitting the sidelink transmission using a third set of resources different from the first set of resources.

A non-transitory computer-readable medium storing code for wireless communications at a second UE is described. The code may include instructions executable by a processor to transmit, to a first UE, SCI indicating a first set of resources for a sidelink transmission, receive, from the first UE, an indication of a conflict between the first set of resources and a second set of resources associated with a third UE based on a first measured power associated with the first UE or a second measure power associated with the second UE, or both, satisfying a condition, and transmit the sidelink transmission using a third set of resources different from the first set of resources.

Some examples of the method, apparatuses, and non-transitory computer-readable medium described herein may further include operations, features, means, or instructions for transmitting the sidelink transmission using the first set of resources based on the conflict occurring prior to receiving the indication of the conflict, where the sidelink transmission using the third set of resources may be a retransmission of the sidelink transmission.

Some examples of the method, apparatuses, and non-transitory computer-readable medium described herein may further include operations, features, means, or instructions for refraining from transmitting the sidelink transmission on the first set of resources based on the conflict occurring after receiving the indication of the conflict.

In some examples of the method, apparatuses, and non-transitory computer-readable medium described herein, the condition may be based on a set of received power thresholds, a set of priority thresholds, a set of priorities, or any combination thereof.

In some examples of the method, apparatuses, and non-transitory computer-readable medium described herein, transmitting the SCI may include operations, features, means, or instructions for transmitting the SCI including a request for the indication of the conflict.

### BRIEF DESCRIPTION OF THE DRAWINGS

FIG. 1 illustrates an example of a wireless communications system that supports reference signal received power (RSRP)-based conflict indication for sidelink inter-user equipment (UE) coordination in accordance with aspects of the present disclosure.

FIG. 2 illustrates an example of a wireless communications systems that supports RSRP-based conflict indication for sidelink inter-UE coordination in accordance with aspects of the present disclosure.

FIG. 3 illustrates an example of a process flow that supports RSRP-based conflict indication for sidelink inter-UE coordination in accordance with aspects of the present disclosure.

FIGS. 4 and 5 show block diagrams of devices that support RSRP-based conflict indication for sidelink inter-UE coordination in accordance with aspects of the present disclosure.

FIG. 6 shows a block diagram of a communications manager that supports RSRP-based conflict indication for sidelink inter-UE coordination in accordance with aspects of the present disclosure.

FIG. 7 shows a diagram of a system including a device that supports RSRP-based conflict indication for sidelink inter-UE coordination in accordance with aspects of the present disclosure.

FIGS. 8 through 12 show flowcharts illustrating methods that support RSRP-based conflict indication for sidelink inter-UE coordination in accordance with aspects of the present disclosure.

### DETAILED DESCRIPTION

Some wireless communications systems may support sidelink communications between devices. Sidelink may refer to any communication link between similar communication devices such as user equipment (UE). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some sidelink communications systems, a UE may select resources for transmitting sidelink communications independent of a resource allocation procedure with a base station or other network entity (e.g., autonomously). In such cases, two transmitting UE may select the same or overlapping resources which may cause a conflict or collision (e.g., a past or potential conflict or collision) between transmissions. In such examples, a helping UE (e.g., a non-conflicting UE) may transmit an inter-UE coordination message including a conflict indication to mitigate the effects of the conflict. For example, when two UEs reserve or transmit using the same or at least partially overlapping resources, the helping UE may transmit an inter-UE coordination message to either or both of the conflicting UEs to indicate the collision. Based on receiving the indication, one or both of the conflicting UEs may take measures such as reselection of resources to avoid the collision, or retransmission of the signaling to increase the likelihood that the signaling will be received by the intended recipient. In some examples, the helping UE may determine whether to transmit the inter-UE coordination message based on location information. In some cases, however, location information may not be available.

Techniques described herein provide for a UE (e.g., a helping UE) to determine whether to transmit an inter-UE coordination message based on a power measurement of a reference signal (e.g., reference signal received power (RSRP)) received from either or both of the conflicting UEs. For example, the helping UE may receive sidelink control information (SCI) signaling from both of the colliding UE indicating the at least partially overlapping resources. The helping UE may determine whether to transmit an inter-UE coordination message to notify a first colliding UE or a second colliding UE, or both, of the conflict based on a received power measurement (e.g., RSRP measurement) of the first UE or the second UE, or both. For example, the helping UE may determine whether to transmit the collision indication based on one or both of the received powers satisfying a set of conditions, such as a set of one or more power thresholds (e.g., RSRP threshold). The third (e.g., helping) UE may also determine to which or both of the first UE and the second UE to transmit the indication based on the power measurements satisfying the set of conditions. The described techniques generally include a number of conditions for these determinations, some of which may additionally be based on the priorities of the conflicting UEs, multiple received power conditions or thresholds, and cast-type (e.g., broadcast, unicast, etc.) as well as conditions for when to use received power-based indications rather than distance-based indications.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to RSRP-based conflict indication for sidelink inter-UE coordination.

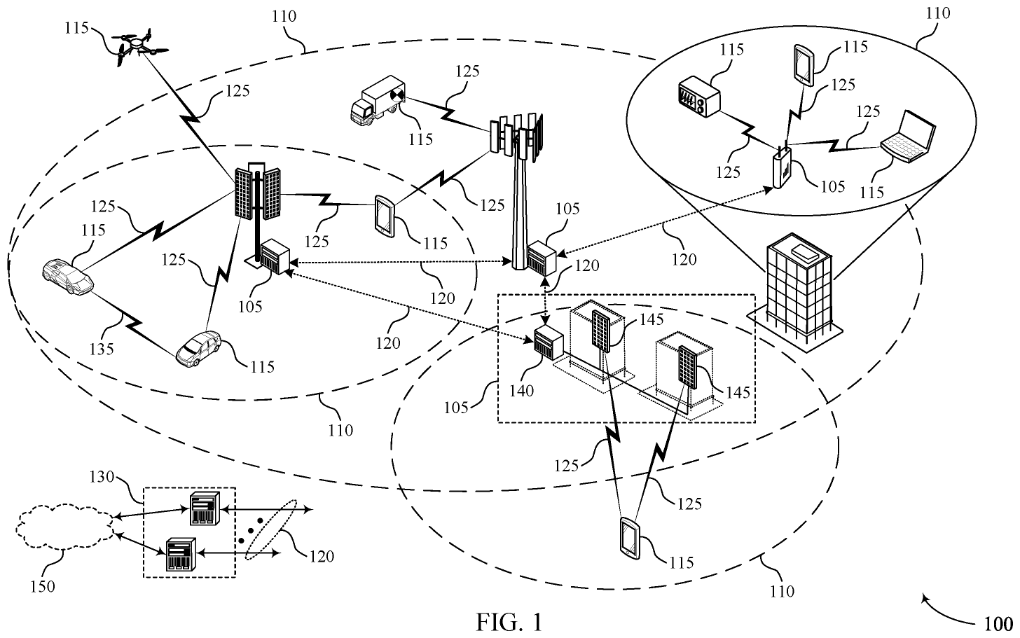

FIG. 1 illustrates an example of a wireless communications system 100 that supports RSRP-based conflict indication for sidelink inter-UE coordination in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may be an example of a sidelink network. Here, the sidelink network may support one or more resource allocation modes to coordinate sidelink communications between UEs 115 (e.g., over D2D communication links 135, over PC5 links). For example, the sidelink network may be configurable to operate according a Mode 1 resource allocation mode and/or a Mode 2 resource allocation mode. While operating in Mode 1, the sidelink network (e.g., sidelink communications over the sidelink network) may be managed (e.g., coordinated) by a base station 105. For example, during Mode 1 operation, the base station 105 may manage sidelink resource allocation over the sidelink network.

While operating in Mode 2, the sidelink network may not be managed or coordinated by the base station 105. Without coordination or management of sidelink resources of the sidelink network during the Mode 2 operation, UEs 115 may follow contention-based access procedures in which the various UEs 115 may reserve sidelink resources of the sidelink network. For example, during Mode 2 operation operating under a first scheme, a UE 115 may monitor the sidelink network to determine if other UEs 115 are attempting to transmit over the sidelink network. For instance, the UE 115 may decode one or more reservation messages (e.g., sidelink control channel transmissions such as SCI messages, SCI-1 messages, SCI-2 messages, request-to-send-messages, or some other sidelink control channel transmissions) and may determine which sidelink resources are reserved for other sidelink communications and which sidelink resources are available for sidelink communications based on the reservation messages. In some other examples, during Mode 2 operation operating under a second scheme, a UE 115 may monitor the sidelink network to determine if other UEs 115 have transmitted or have reserved the same or overlapping resources for transmission. In such examples, the UE 115 may determine whether and to which conflicting UEs to transmit an inter-UE coordination message based on a physical distance between the helping UE and the conflicting UEs or based on a received power (e.g., an RSRP measurement) associated with the conflicting UEs, a priority of the conflicting transmission, or some combination thereof.

For example, two UEs 115 may have a collision or scheduling conflict within a slot. In some examples, the two transmissions may be on the same or overlapping resources, such that an intended receiver may not be able to decode one or more of the transmissions due to interference. In another example, the two transmissions may occur within a same slot, so one or both of the UEs 115 may not be able to listen to each other due to half-duplex constraints (e.g., one or more of the UEs 115 may not support simultaneous transmission and reception). A third UE 115 may have received at least control signaling (e.g., SCI such as SCI-1 or SCI-2) from both of the colliding or conflicting UEs 115. The collision or conflict may be in a present slot, a past slot (e.g., the collision has already occurred), or in a later slot (e.g., the conflict is scheduled, but has not yet occurred).

In an example, a helping UE may receive a first SCI from a first conflicting UE and a second SCI from a second conflicting UE. The first SCI may indicate a first set of resources on which the first conflicting UE used or may have reserved and the second SCI may indicate a second set of resources on which the second conflicting UE used or may have reserved that at least partially overlap with the first set of resources. The helping UE may measure a first received power (e.g., such as RSRP) associated with the first conflicting UE) or a second received power associated with the second conflicting UE, or both, based on the second set of resources partially overlapping with the first set of resources. The helping UE may transmit, to the first conflicting UE or the second conflicting UE, or both, an indication of a conflict based at least in part on the first received power or the second received power or both, satisfying a condition. In some examples, transmitting the indication of the conflict may be further based on a priority of either or both of the conflicting transmissions.

In some cases, the received power between UEs 115 may approximate the distance between a helping UE 115 and either or both of the conflicting UEs 115. The closer two UEs 115 are to each other, the stronger the received power and the further away two UEs 115 are from each other, the weaker the received power. In such a manner, the received power measurements associated with the conflicting UEs 115 may serve as a proxy when physical distance is unavailable or unattainable or may serve in addition to location-based inter-UE coordination. Thus, the helping UE 115 may determine to transmit the inter-UE coordination message based on how close it is to either or both of the conflicting UEs as approximated by the measured received power when physical location is unavailable or determining a physical location is less ideal. In some examples, a wireless communications system 100 may support a power-based inter-UE coordination technique separate from or in addition to a distance-based inter-UE coordination technique. For example, some wireless communications systems may implement only an RSRP-based approach for conflict indication, regardless of availability for distance information or advanced positioning techniques. The RSRP-based techniques (e.g., power-based techniques) for sidelink conflict indication may be implemented for some scenarios or some cast types, or the RSRP-based techniques may be implemented for all scenarios and all cast types. In some cases, the RSRP-based technique may be reliably available, as implementing a distance-based technique may be contingent on distance information being available or determinable.

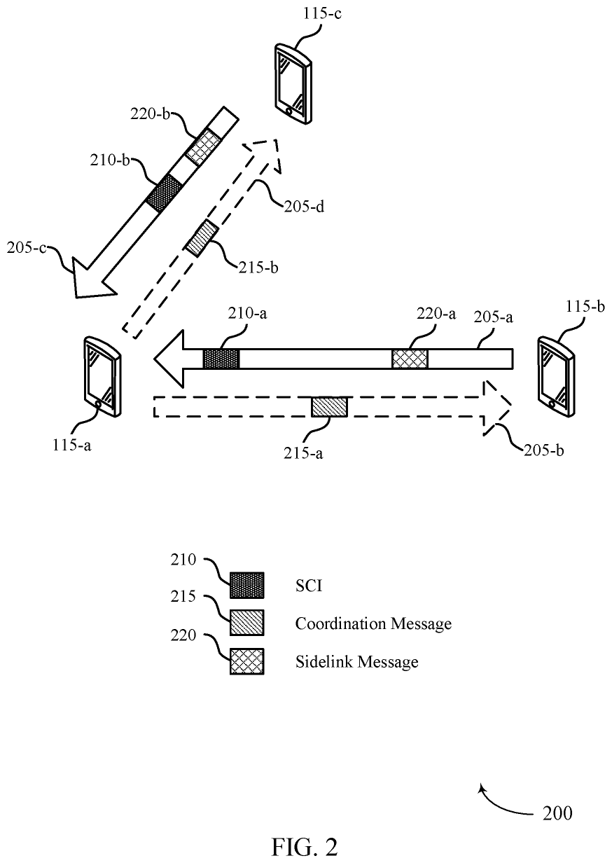

FIG. 2 illustrates an example of a wireless communications system 200 that supports RSRP-based conflict indication for sidelink inter-UE coordination in accordance with aspects of the present disclosure. The wireless communications system 200 may implement aspects of the wireless communications system 100 or may be implemented by aspects of the wireless communications system 100. For example, the wireless communications system 200 may include a UE 115-a, a UE 115-b, and a UE 115-c which may each be an example of a UE 115 described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support RSRP-based conflict indication to support improvements to reliability, sidelink resource selection and reservation, latency, and coordination between devices among other benefits.

The wireless communications system 200 may support sidelink communications between the UE 115-a and the UE 115-b and between the UE 115-a and the UE 115-c. For example, the UE 115-b may transmit and the UE 115-a may receive sidelink communications over a sidelink 205-a. In some examples, the UE 115-a may transmit and the UE 115-c may receive sidelink communications over a sidelink 205-d, and the UE 115-a may transmit and the UE 115-b may receive sidelink communications over a sidelink 205-b. Additionally, the UE 115-c may transmit and the UE 115-a may receive sidelink communications over a sidelink 205-c. In some cases, the sidelinks 205 may be examples of D2D communication links 135 as described with reference to FIG. 1.

The wireless communications system 200 may be configured to operate according to a Mode 2 resource allocation mode. For example, the UE 115-a may monitor respective sidelinks 205 for SCI 210 and may detect a conflict between resources used or reserved by UE 115-b and UE 115-c. For example, UE 115-b and UE 115-c may have autonomously (e.g., independent from a resource allocation procedure with a network entity) reserved resources for sidelink communications as indicated in SCI 210. However, UE 115-b and UE 115-c may have reserved the same or overlapping resources, causing a past collision or potential conflict. For instance, the UE 115-b and UE 115-a may transmit SCI 210-a and 210-b, respectively, to one or more UEs 115, including UE 115-a, to reserve resources for sidelink signaling. Accordingly, the UE 115-a may receive and decode the SCI 210 and may determine that the sidelink resources reserved or used by the UE 115-b and UE 115-c at least partially overlap, causing a past or potential conflict. The sidelink resources may be reserved for sidelink messages 220 to the UE 115-a or between the conflicting UEs (e.g., the UEs 115-b and 115-c in this example) or to another UE 115.

The UE 115-a may determine to notify the UE 115-b or the UE 115-c, or both, of the conflict (e.g., past or potential conflict) based on a number of conditions. For example, the UE 115-a may transmit an inter-UE coordination message 215 to one or more of the conflicting UE 115-b or UE 115-c. The inter-UE coordination message 215 may indicate the conflict such that the recipients may take action to avoid or mitigate the conflict (e.g., such as retransmission or reselection of resources) and may include a conflict indication among any number of other indications for inter-UE coordination (e.g., coordination to avoid resource collisions). For example, the conflict indication may be transmitted with an indication of a set of preferred or non-preferred resources for Mode 2 resource allocation at the UE 115-b or UE 115-c. The inter-UE coordination message 215 may be transmitted as a sequence-type signal (e.g., such as a physical sidelink control channel (PSFCH), or the like) or in other control signaling (e.g., such as physical (PHY) layer signaling, MAC signaling (e.g., such as via MAC-control element (CE) signaling), RRC, or the like).

In some examples, the UE 115-a may determine whether and to which of the conflicting UEs 115-b and UE 115-c to transmit the inter-UE coordination message 215 based on a distance between the UE 115-a and each or one of the conflicting UEs 115-b and UE 115-c. The UE 115-b and UE 115-c may transmit their respective location information (e.g., global navigation satellite system coordinates (GNSS), zone ID, or the like), which the UE 115-a may use in addition to its own location information to determine a physical distance between the UE 115-a and the UE 115-b or UE-115-c or both. For example, the UE 115-a may determine to transmit the inter-UE coordination message 215 using a distance-based condition.

However, in some cases, the location information of one or more of the UEs 115 may be unavailable. For example, one or more of the UE 115 may be operating in a broadcast, unicast, or feedback-based groupcast (e.g., negative acknowledgement (NACK) feedback groupcast) communications mode where RRC connection between UE 115 may be unavailable and thus transmitting location information RRC signaling between UE 115 may be impractical. In some other examples, one or more of the UE 115 may be able to access location information but some layers of the UE 115 protocol stack (e.g., PHY layer, MAC layer, or the like) may not have access to the location information and as such may be unable to communicate its location to other UEs 115. For example, the UE 115 may receive GNSS coordinates but may not be configured to calculate zone ID at the PHY or MAC layers. In some other examples, the location coordinates of the UE 115 may be unavailable. For example, the UE 115 may be out of range of some satellite communications or network communications and may be unable to determine its location. In some examples, the UE 115 may be configured with a configuration (e.g., an RRC configuration) that configures the UE 115 use an alternative to distance-based inter-UE coordination in addition to or instead of the distance-based inter-UE coordination even if location information is available.

The wireless communications system 200 may implement techniques for a received power-based inter-UE coordination scheme. In some cases, the received power-based inter-UE coordination scheme may be an alternative to the distance-based inter-UE coordination scheme (e.g., if distance-based inter-UE coordination is unavailable). For example, the UE 115-a may determine to transmit the inter-UE coordination message 215 based on a measured RSRP associated with the UE 115-b or the UE 115-c, or both, satisfying a condition, such as a set of one or more RSRP thresholds or a set of one or more transmission priority thresholds. For example, the UE 115-a may determine a set of thresholds for power-based inter-UE coordination. In some cases, UE 115-a may receive the set of thresholds from the network (e.g., via RRC signaling, via a system information block (SIB), or the like). Additionally, or alternatively, UE 115-a may receive one or more thresholds in the set of thresholds via SCI 210-a or 210-b, or both.

In some cases, UE 115-a may determine a set of RSRP thresholds based on a mapping between an RSRP threshold and a transmission priority of the conflicting transmission. For example, different priority signaling may have different RSRP thresholds. For example, a higher priority transmission may be associated with a smaller lower-bound RSRP threshold or a larger upper-bound RSRP threshold, or both. In some cases, a lower priority transmission may be associated with a larger lower-bound RSRP threshold or a smaller upper-bound RSRP threshold, or both. In some cases, these techniques may prioritize transmissions with higher priorities.

The UE 115-a may measure a first RSRP and a second RSRP associated with reference signals received from the UE 115-b and the UE 115-c, respectively, and may compare the measured received powers to the set of thresholds. The UE 115-a may determine whether to transmit the inter-UE coordination message 215-a or 215-b, or both, based on one or both of the received powers satisfying the set of thresholds. The UE 115-a may perform the RSRP measurements based on the SCI 210-a and the SCI 210-b (e.g., based on reference signals in the SCIs 210) or based on other signaling received from the UE 115-b and the UE 115-c (e.g., the sidelink messages 220).

In some examples, the set of thresholds may include a lower-bound RSRP threshold. In some cases, the UE 115-a may determine to transmit the inter-UE coordination message 215 if both received power measurements are above the lower-bound received power threshold. That is, the UE 115-a may determine that each of the first RSRP and the second RSRP exceed the lower-bound RSRP threshold. In some cases, if both RSRPs exceed the lower-bound RSRP threshold, this may indicate that both the UE 115-b and the UE 115-c are close enough to the UE 115-a that the UE 115-a can effectively transmit the inter-UE coordination message 215. In some other examples, the UE 115-a may determine to transmit the inter-UE coordination message 215 if either of the received power measurements are above a received power threshold. That is, the UE 115-a may determine to transmit the inter-UE coordination message 215 if at least one RSRP measurement (e.g., of the first RSRP and the second RSRP) exceeds an RSRP threshold. This may indicate that at least one of the UE 115-b or UE 115-c are close enough to the UE 115-a that the UE 115-a can effectively transmit the inter-UE coordination message 215. By implementing these techniques, a total number of UEs 115 (such as UE 115-a) transmitting the inter-UE coordination message 215 may be limited. For example, UEs 115 close to the conflicting UE 115-b and 115-c may determine to transmit the inter-UE coordination message 215, and UEs 115 farther away may not transmit an inter-UE coordination message, reducing excess signaling.

In some examples, the set of one or more thresholds may include an upper-bound RSRP threshold. In some cases, the UE 115-a may determine to transmit the inter-UE coordination message 215 if both received power measurements are below the upper-bound received power threshold. For example, the UE 115-a may determine that each of the first RSRP and the second RSRP satisfy the upper-bound RSRP threshold which may indicate that each of the UE 115-b and UE 115-c are far enough from the UE 115-a that the UE 115-a can effectively transmit the inter-UE coordination message 215 without causing interference at the conflicting UE 115-b or UE 115-c. In some examples, the UE 115-a may determine to transmit the inter-UE coordination message 215 if either of the received power measurements are below the upper-bound RSRP threshold. That is, the UE 115-a may determine that at least one of the first RSRP and the second RSRP satisfy the upper-bound RSRP threshold. This may indicate that at least one of the UE 115-b or UE 115-c are far enough from the UE 115-a that the UE 115-a can effectively transmit the inter-UE coordination message 215 without causing interference to at least one of the UEs 115. In such a manner, the UE 115-a may limit the amount of interference caused at either or both of the UE 115-b and UE 115-c when transmitting the inter-UE coordination message 215 by determining to transmit the inter-UE coordination message when the UE 115-a is far enough away from at least one of the conflicting UEs 115 to prevent causing additional interference.

In some examples, the set of thresholds may include a lower-bound RSRP threshold and an upper-bound RSRP threshold. For example, the UE 115-a may determine to transmit the inter-UE coordination message 215 if both of the first RSRP and the second RSRP are bound by the lower-bound threshold and the upper-bound threshold. Alternatively, the UE 115-a may determine to transmit the inter-UE coordination message 215 if at least one of the first RSRP or the second RSRP are bound by the lower-bound threshold and the upper-bound threshold.

In some examples, the set of thresholds may additionally or alternatively include a set of priority thresholds. For example, the UE 115-a may determine to transmit the inter-UE coordination message if the RSRP of the UE 115-b or UE 115-c satisfied one or more RSRP thresholds as described herein and if either or both of the transmissions scheduled by the SCI 210-a or SCI 210-b satisfy a set of priority thresholds. Determinations for transmitting the inter-UE coordination message based on priority thresholds may be similar in scope to determinations based on one or more of the RSRP thresholds described herein. In such cases, conflicting transmissions within a priority range or satisfying a certain priority threshold may be indicated by an inter-UE coordination message 215. For example, the UE 115-a may transmit the inter-UE coordination message 215 if sidelink signaling from the UE 115-b or the UE 115-c, or both, satisfies one or more priority thresholds (e.g., in addition to satisfying one or more power-based thresholds). In some cases, the UE 115-b and the UE 115-c may include an indication of priority in the SCI 210-a and the SCI 210-b, respectively.

In some examples, a UE 115 may request for the confliction indication. In some examples, such a request may be transmitted via the SCI 210-a or the SCI 210-b, or both. In some examples, the UE 115-a may determine to transmit the inter-UE coordination message if the RSRP of the UE 115-b or UE 115-c satisfies one or more RSRP thresholds as described herein and if the inter-UE coordination message is requested by one or more of the UE 115-b or UE 115-c.

In some examples, the UE 115-a may select a recipient (e.g., one of UE 115-b or UE 115-c) of the inter-UE coordination message 215 and may measure the RSRP associated with the selected recipient. For example, the UE 115-a may determine a recipient for the conflict indication first, such as prior to performing an RSRP measurement. In some example, the UE 115-a may select a recipient based on the priorities of the conflicting messages. For example, the UE 115-a may select a recipient having the higher priority transmission or may select a recipient having a lower priority transmission or based on one or more of the conflicting transmissions satisfying a set of priority thresholds. The UE 115-a may determine whether to transmit the inter-UE coordination message 215 to the selected recipient based on the measured RSRP of the selected recipient satisfying the set of thresholds (which may include any of the threshold mechanisms described herein). In such a manner, the UE 115-a may conserve processing resources by measuring a single RSRP (e.g., the RSRP associated with the intended recipient).

Additionally, or alternatively, the UE 115-a may determine to transmit the inter-UE coordination message 215 to the UE 115-b or the UE 115-c, or both. For example, the UE 115-a may determine to transmit the inter UE coordination messages-215 to both of the UE 115-b and UE 115-c, or the UE 115-a may determine to transmit the inter-UE coordination messages 215 to either the UE 115-b or UE 115-c. In some examples, the UE 115-a may determine which of the UE 115-b and UE 115-c is the intended recipient based on measured RSRP. For example, the UE 115-a may transmit the inter-UE conflict indication to the conflicting UE 115-b or UE 115-c associated with a higher RSRP. In some examples, the inter-UE conflict indication may be transmitted to the conflicting UE 115-b or UE 115-c associated with a lower RSRP.

In some examples, The UE 115-a may determine the recipient based on transmission priority. For example, the UE 115-a may transmit the inter-UE conflict indication to the conflicting UE 115 associated with a higher transmission priority. For example, the UE 115-a may transmit to the UE 115 (e.g., between the UE 115-b and UE 115-c) that will be transmitting or has transmitted a higher priority transmission on the reserved or used resources. In some examples, the conflict indication may be transmitted to the conflicting UE 115 (e.g., between the UE 115-b and the UE 115-c) associated with a lower priority.

In some examples, the recipient of the inter-UE coordination message 215 may be determined based on a timing of the conflict. For example, if the UE 115-a detects a collision that has already occurred between transmissions from the UE 115-b and the UE 115-c, the UE 115-a may transmit the inter-UE coordination message 215 to the UE 115 associated with the higher priority transmission, such that the UE 115 which transmitted higher priority signaling may retransmit the sidelink message 220 using different resources. In some cases, if the UE 115-a detects a conflict that has not yet occurred, the UE 115-a may transmit the inter-UE coordination message 215 to the UE 115 associated with the lower priority signaling, such that the UE 115 associated with lower priority signaling may select different resources or cancel the sidelink message 220. In some examples, the UE 115-a may randomly select a recipient of the inter-UE coordination message, or the UE 115-a may select a recipient based on RSRP conditions if the transmissions from the UE 115-b and UE 115-c are associated with a same priority.

As such, the UE 115-a may determine whether and to which UEs to transmit the inter-UE coordination message 215 for indicating past or future conflicts between transmitting UE 115.

It is to be understood that any of the presented conditions for transmitting the inter-UE coordination message 215 may be implemented in conjunction with any number of other example conditions. For example, the conditions for determining whether to transmit the inter-UE coordination message 215 may be combined with each other or may be combined with one or more of the various conditions for determining which UE 115 to which to transmit the coordination message. That is, the UE 115-a may use several conditions for determining whether and to which UE 115 to transmit the coordination message and it is to be understood that while each of the examples presented may be implemented individually they may be implemented in any combination thereof.

In some cases, the UE 115-a may use a distance-based inter-UE coordination scheme or a power-based inter-UE coordination scheme, or both. In some cases, the power-based inter-UE coordination scheme may be used when a distance-based inter-UE coordination scheme is unavailable. For example, if the UE 115-a, the UE 115-b, or the UE 115-c, or any combination thereof, do not have available location information or cannot determine a zone ID, the UE 115-a may use a power-based inter-UE coordination scheme. In some cases, the UE 115-a may be configured to use either the distance-based inter-UE coordination scheme or the power-based inter-UE coordination scheme. For example, the UE 115-a may support both types of inter-UE coordination schemes, and the network or another UE 115 may indicate, configure, or request for the UE 115-a to use either the distance-based inter-UE coordination scheme or the power-based inter-UE coordination scheme. In some cases, the UE 115-a may determine an inter-UE coordination scheme based on a cast type of the sidelink signaling (e.g., the colliding or conflicting sidelink signaling). For example, if at least one colliding UE 115 is transmitting using unicast signaling, broadcast signaling, or acknowledgment (ACK)-based groupcast signaling, the UE 115-a may use a power-based inter-UE coordination scheme. In another example, if one or more of the colliding UEs 115 is transmitting using NACK-based groupcast (e.g., NACK only-based feedback groupcast), the UE 115-a may use the distance-based inter-UE coordination scheme (e.g., if available).

In some examples, a wireless communications system, such as the wireless communications system 100 or the wireless communication system 200, may support a power-based inter-UE coordination technique separate from or in addition to a distance-based inter-UE coordination technique. For example, some wireless communications systems may implement only an RSRP-based approach for conflict indication, regardless of availability for distance information or advanced positioning techniques. The RSRP-based techniques (e.g., power-based techniques) for sidelink conflict indication may be implemented for some scenarios or some cast types, or the RSRP-based techniques may be implemented for all scenarios and all cast types. In some cases, the RSRP-based technique may be reliably available, as implementing a distance-based technique may be contingent on distance information being available or determinable.

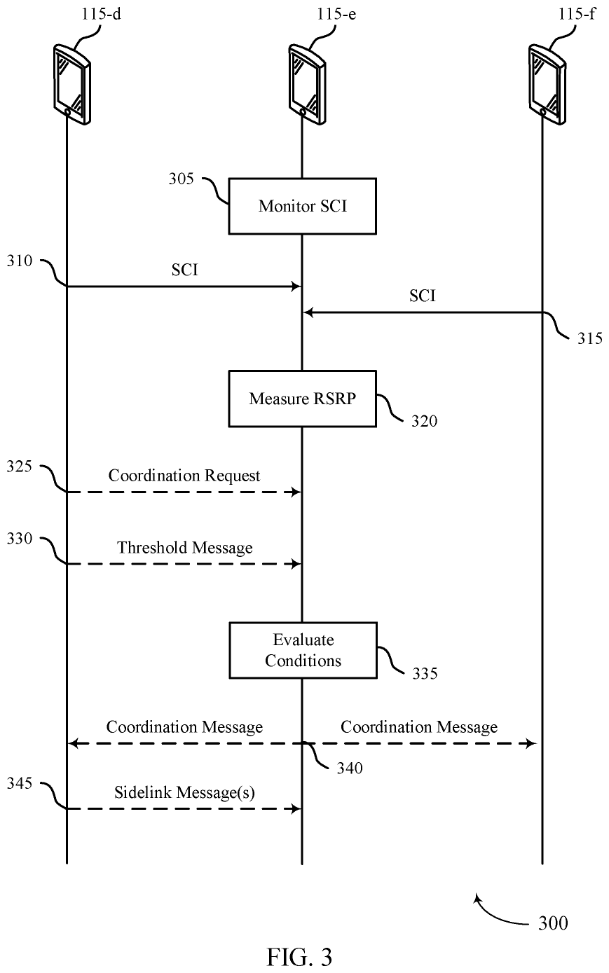

FIG. 3 illustrates an example of a process flow 300 that supports RSRP-based conflict indication for sidelink inter-UE coordination in accordance with aspects of the present disclosure. The process flow 300 may be implemented by a UE 115-d, a UE 115-e, or a UE 115-f, or any combination thereof. The UEs 115 may be examples of UEs 115 of a wireless communications system as described with reference to FIG. 1 or 2. In the following description of the process flow 300, the operations between the UE 115-d, the UE 115-e, and the UE 115-f may be performed in different orders or at different times. Certain operations may also be left out of the process flow 300, or other operations may be added.

At 305, the UE 115-e may monitor for SCI. For example, for some sidelink communications techniques, UEs 115 may transmit SCI to reserve resources for sidelink data transmissions. At 310 and 315, the UE 115-e may receive SCI from the UE 115-d and the UE 115-f based on monitoring for SCI. For example, the UE 115-e may receive a first SCI from the UE 115-d and a second SCI from the UE 115-f. The first SCI may indicate a first set of resources and the second SCI may indicate a second set of resources, which may at least partially overlap with the first set of resources or occur within a same slot as the first set of resources.

In some cases, based on the first set of resources overlapping with the second set of resources, the UE 115-e may determine that a first sidelink data transmission from the UE 115-d is scheduled to collide with a second sidelink data transmission from the UE 115-f. For example, the UE 115-d and the UE 115-f may each reserve at least partially overlapping resources. The UE 115-e may detect the scheduled collision based on the resource reservation indications in the SCIs. In some other examples, the UE 115-e may determine, or detect, a collision between sidelink data transmissions based on two UEs 115 transmitting sidelink data on the same resources. For example, the UE 115-e may determine the scheduling conflict prior to a collision based on overlapping resource reservations in SCI, or the UE 115-e may detect a collision after the collision has occurred based on receiving both sidelink data transmissions on overlapping resources, or both.

In some cases, the UE 115-d or the UE 115-f, or both, may transmit a coordination request or an indication of a threshold, or both. For example, the UE 115-d may transmit a coordination request at 320 or a threshold message at 325, or both. In some cases, the coordination request or the threshold message, or both, may be included in SCI (e.g., the SCI transmitted at 310). In some cases, the coordination request may request for neighboring UEs 115 to indicate whether the UE 115-d has reserved resources which may collide with sidelink transmissions with other UEs 115. For example, the coordination request may request for the UE 115-e to transmit an inter-UE coordination message (e.g., a conflict indication or collision indication) to the UE 115-d or another colliding UE 115.

At 330, the UE 115-e may measure a first received power associated with the UE 115-d or a second received power associated with the UE 115-e, or both. In some cases, the UE 115-e may measure the first received power and the second received power based on the second set of resources at least partially overlapping with the first set of resources. In some cases, the UE 115-e may measure an RSRP from the UE 115-d or the UE 115-f, or both.

At 335, the UE 115-e may determine whether to transmit an indication of a conflict (e.g., a scheduling conflict) to the UE 115-d or the UE 115-f, or both. The indication of the conflict may be transmitted in, or included with, an inter-UE coordination message. The UE 115-e may determine whether to transmit the indication of the conflict based on the first received power or the second received power, or both, satisfying a condition. For example, the UE 115-e may determine whether to transmit the indication of the conflict based on one or more of the measured received powers satisfying a power threshold or a priority threshold, or both. In some cases, the UE 115-e may receive the power threshold from a network entity. Additionally, or alternatively, the UE 115-e may receive the power threshold via the first SCI (e.g., from the UE 115-d) or the second SCI (e.g., from the UE 115-f). In some cases, the UE 115-e may determine the power threshold based on a configuration of the UE 115-e. For example, the UE 115-e may be configured, or pre-configured, to determine a power threshold for determining whether to transmit inter-UE coordination messages.

In some cases, the UE 115-e may transmit an indication of a conflict if both of the measured received powers exceed a power threshold. In some cases, the UE 115-e may transmit the indication of the conflict if either of the first received power or the second received power exceed a power threshold. In some examples, the UE 115-e may transmit the indication of the conflict if both measured received powers are smaller than a power threshold. In some cases, the UE 115-e may transmit the indication of the conflict if either of the measured received powers are smaller than the power threshold.

In some cases, the UE 115-e may determine whether to transmit the indication of the conflict based on multiple power thresholds. In some cases, the UE 115-e may be configured with a lower bound power threshold and an upper bound power threshold. For example, the UE 115-e may determine to transmit the indication of the conflict if either the first received power or the second received power is between a first power threshold (e.g., the lower bound power threshold) and a second power threshold (e.g., the upper bound power threshold). In some cases, the UE 115-e may determine to transmit the indication of the conflict if both the first received power and the second received power are between the first power threshold and the second power threshold.

In some cases, the UE 115-e may determine whether to transmit the indication of the conflict based on the priority of the sidelink transmissions. For example, the UE 115-e may determine to transmit the conflict indication if the RSRP measurements satisfy the power threshold and either, or both, of the colliding sidelink transmissions satisfy a priority threshold. For example, the UE 115-e may determine to transmit the indication of the conflict if one or more of the colliding sidelink data transmissions are high priority signaling.

At 340, the UE 115-e may transmit, to the UE 115-d or the UE 115-e, or both, the indication of the conflict based on the first received power or the second received, or both, satisfying the condition. In some cases, the UE 115-e may determine a recipient for the conflict indication based on the received power measurements (e.g., RSRP measurements). In some examples, the UE 115-e may transmit the conflict indication to the UE 115 with greater RSRP. For example, the UE 115-e may determine that the first received power or the second received power, or both, satisfy the condition, and the received power measurement of the UE 115-d may be greater than the received power measurement of the UE 115-f. In this example, the UE 115-e may transmit the indication of the conflict to the UE 115-d. In some other examples, the UE 115-e may transmit the indication of the conflict to the UE 115 with the smaller RSRP. In some cases, the UE 115-e may transmit an indication of the conflict to both UEs 115.

In some cases, the UE 115-e may determine the recipient of the indication based on priority. For example, the UE 115-d and the UE 115-f may include a priority indication in the first SCI and the second SCI. In some cases, UE 115-e may transmit the indication of the conflict to the UE 115 with higher priority. For example, for a post-collision indication (e.g., where the indication of the conflict is transmitted after a collision occurs), the UE 115-e may transmit the indication of the conflict to the UE 115 with higher priority signaling. This may enable the UE 115 receiving the indication to quickly prepare a retransmission of the high priority signaling. In some examples, the UE 115-e may transmit the indication of the conflict to the UE 115 with lower priority. For example, for a pre-collision indication (e.g., where the indication of the conflict is transmitted before the conflicting resources), the UE 115-e may transmit the indication of the conflict to the UE 115 with a lower priority. This may enable the UE 115 receiving the indication to select different resources for the lower priority signaling without disrupting the higher priority signaling

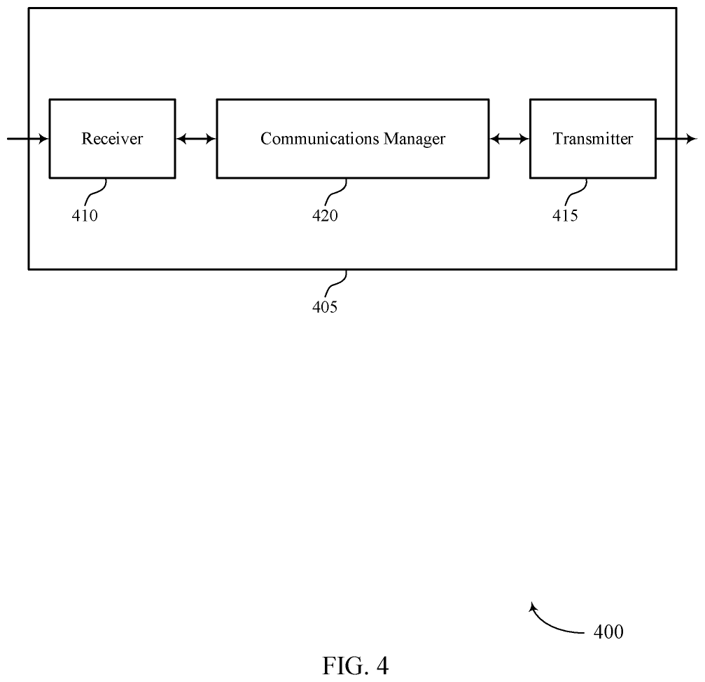

FIG. 4 shows a block diagram 400 of a device 405 that supports RSRP-based conflict indication for sidelink inter-UE coordination in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to RSRP-based conflict indication for sidelink inter-UE coordination). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to RSRP-based conflict indication for sidelink inter-UE coordination). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of RSRP-based conflict indication for sidelink inter-UE coordination as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a first UE in accordance with examples as disclosed herein. For example, the communications manager 420 may be configured as or otherwise support a means for receiving a first SCI from a second UE and a second SCI from a third UE, the first SCI indicating a first set of resources and the second SCI indicating a second set of resources that at least partially overlap with the first set of resources. The communications manager 420 may be configured as or otherwise support a means for measuring a first received power associated with the second UE or a second received power associated with the third UE, or both, based on the second set of resources partially overlapping with the first set of resources. The communications manager 420 may be configured as or otherwise support a means for transmitting, to the second UE or the third UE, or both, an indication of a conflict based on the first received power or the second received power or both, satisfying a condition.

Additionally, or alternatively, the communications manager 420 may support wireless communications at a second UE in accordance with examples as disclosed herein. For example, the communications manager 420 may be configured as or otherwise support a means for transmitting, to a first UE, SCI indicating a first set of resources for a sidelink transmission. The communications manager 420 may be configured as or otherwise support a means for receiving, from the first UE, an indication of a conflict between the first set of resources and a second set of resources associated with a third UE based on a first measured power associated with the first UE or a second measure power associated with the second UE, or both, satisfying a condition. The communications manager 420 may be configured as or otherwise support a means for transmitting the sidelink transmission using a third set of resources different from the first set of resources.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, more efficient utilization of communication resources, or the like.

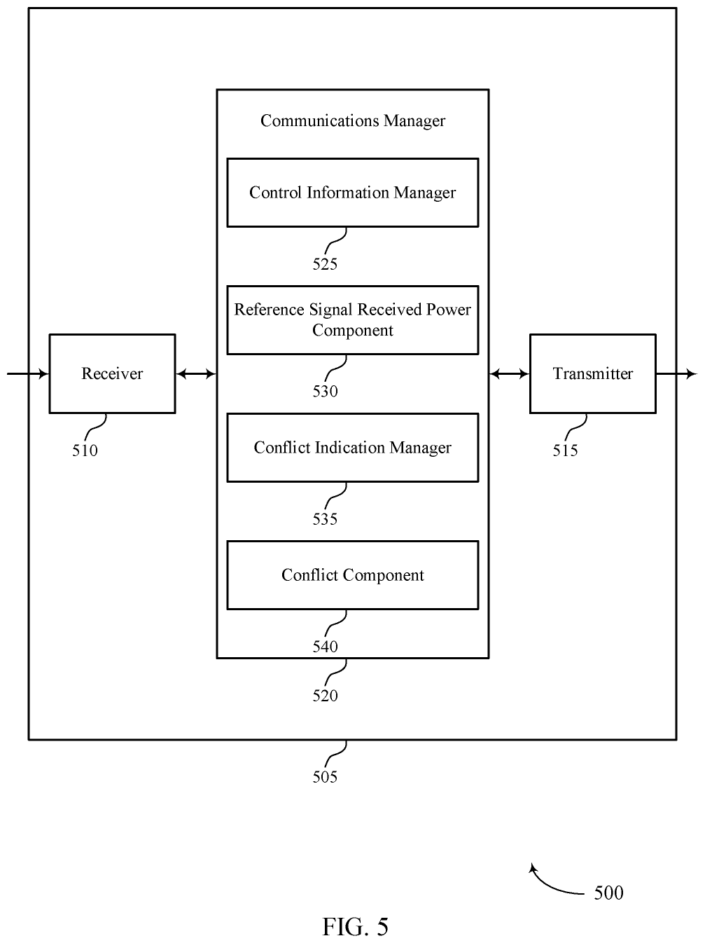

FIG. 5 shows a block diagram 500 of a device 505 that supports RSRP-based conflict indication for sidelink inter-UE coordination in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to RSRP-based conflict indication for sidelink inter-UE coordination). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RSRP-based conflict indication for sidelink inter-UE coordination). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of RSRP-based conflict indication for sidelink inter-UE coordination as described herein. For example, the communications manager 520 may include a control information manager 525, an RSRP component 530, a conflict indication manager 535, a conflict component 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. The control information manager 525 may be configured as or otherwise support a means for receiving a first SCI from a second UE and a second SCI from a third UE, the first SCI indicating a first set of resources and the second SCI indicating a second set of resources that at least partially overlap with the first set of resources. The RSRP component 530 may be configured as or otherwise support a means for measuring a first received power associated with the second UE or a second received power associated with the third UE, or both, based on the second set of resources partially overlapping with the first set of resources. The conflict indication manager 535 may be configured as or otherwise support a means for transmitting, to the second UE or the third UE, or both, an indication of a conflict based on the first received power or the second received power or both, satisfying a condition.

Additionally, or alternatively, the communications manager 520 may support wireless communications at a second UE in accordance with examples as disclosed herein. The control information manager 525 may be configured as or otherwise support a means for transmitting, to a first UE, SCI indicating a first set of resources for a sidelink transmission. The conflict indication manager 535 may be configured as or otherwise support a means for receiving, from the first UE, an indication of a conflict between the first set of resources and a second set of resources associated with a third UE based on a first measured power associated with the first UE or a second measure power associated with the second UE, or both, satisfying a condition. The conflict component 540 may be configured as or otherwise support a means for transmitting the sidelink transmission using a third set of resources different from the first set of resources.

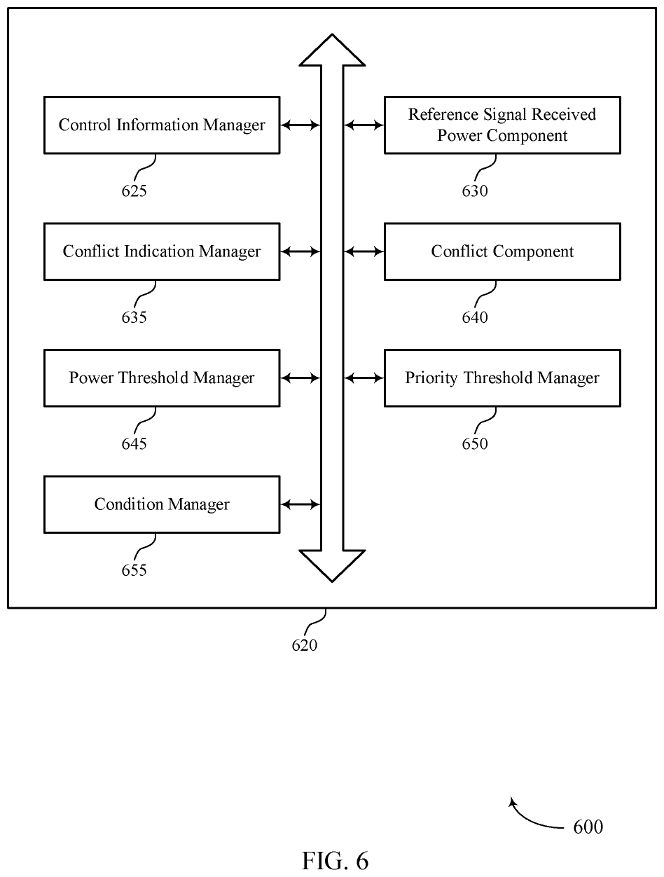

FIG. 6 shows a block diagram 600 of a communications manager 620 that supports RSRP-based conflict indication for sidelink inter-UE coordination in accordance with aspects of the present disclosure. The communications manager 620 may be an example of aspects of a communications manager 420, a communications manager 520, or both, as described herein. The communications manager 620, or various components thereof, may be an example of means for performing various aspects of RSRP-based conflict indication for sidelink inter-UE coordination as described herein. For example, the communications manager 620 may include a control information manager 625, an RSRP component 630, a conflict indication manager 635, a conflict component 640, a power threshold manager 645, a priority threshold manager 650, a condition manager 655, or any combination thereof. Each of these components may communicate, directly or indirectly, with one another (e.g., via one or more buses).

The communications manager 620 may support wireless communications at a first UE in accordance with examples as disclosed herein. The control information manager 625 may be configured as or otherwise support a means for receiving a first SCI from a second UE and a second SCI from a third UE, the first SCI indicating a first set of resources and the second SCI indicating a second set of resources that at least partially overlap with the first set of resources. The RSRP component 630 may be configured as or otherwise support a means for measuring a first received power associated with the second UE or a second received power associated with the third UE, or both, based on the second set of resources partially overlapping with the first set of resources. The conflict indication manager 635 may be configured as or otherwise support a means for transmitting, to the second UE or the third UE, or both, an indication of a conflict based on the first received power or the second received power or both, satisfying a condition.

In some examples, the condition is based on a power threshold, and the power threshold manager 645 may be configured as or otherwise support a means for receiving the power threshold from a network entity. In some examples, the condition is based on a power threshold, and the power threshold manager 645 may be configured as or otherwise support a means for receiving the power threshold via the first SCI or the second SCI, or both. In some examples, the condition is based on a power threshold, and the power threshold manager 645 may be configured as or otherwise support a means for determining the power threshold based on a configuration of the first UE.

In some examples, to support measuring, the RSRP component 630 may be configured as or otherwise support a means for measuring the first received power associated with the second UE. In some examples, to support measuring, the RSRP component 630 may be configured as or otherwise support a means for measuring the second received power associated with the third UE.

In some examples, the condition manager 655 may be configured as or otherwise support a means for determining the condition is satisfied based on the first received power exceeding a power threshold or the second received power exceeding the power threshold, or both.

In some examples, the condition manager 655 may be configured as or otherwise support a means for determining the condition is satisfied based on the first received power being less than a power threshold or the second received power being less than the power threshold, or both.

In some examples, the condition is based on a first power threshold and a second power threshold that is greater than the first power threshold, and the power threshold manager 645 may be configured as or otherwise support a means for receiving the first power threshold or the second power threshold, or both, from a network entity. In some examples, the condition is based on a first power threshold and a second power threshold that is greater than the first power threshold, and the power threshold manager 645 may be configured as or otherwise support a means for receiving the first power threshold or the second power threshold, or both, via the first SCI or the second SCI, or both. In some examples, the condition is based on a first power threshold and a second power threshold that is greater than the first power threshold, and the power threshold manager 645 may be configured as or otherwise support a means for determining the first power threshold or the second power threshold, or both, based on a configuration of the first UE.

In some examples, the condition manager 655 may be configured as or otherwise support a means for determining the condition is satisfied based on the first received power or the second received power, or both, being greater than the first power threshold and less than the second power threshold.

In some examples, the condition to transmit the indication of the conflict is based at least on in part on a first priority associated with the second UE or a second priority associated with the third UE.

In some examples, the condition is further based on a priority threshold, and the priority threshold manager 650 may be configured as or otherwise support a means for receiving the priority threshold from a network entity. In some examples, the condition is further based on a priority threshold, and the priority threshold manager 650 may be configured as or otherwise support a means for receiving the priority threshold via the first SCI or the second SCI, or both. In some examples, the condition is further based on a priority threshold, and the priority threshold manager 650 may be configured as or otherwise support a means for determining the priority threshold based on a configuration of the first UE.

In some examples, to support transmitting the indication of the conflict, the conflict indication manager 635 may be configured as or otherwise support a means for transmitting the indication of the conflict based on a first priority of the second UE satisfying the priority threshold or a second priority of the third UE satisfying the priority threshold, or both.

In some examples, the first SCI or the second SCI includes a request for the indication of the conflict. In some examples, the indication of the conflict is transmitted based on the request.

In some examples, to support transmitting the indication of the conflict, the conflict indication manager 635 may be configured as or otherwise support a means for transmitting the indication of the conflict to the second UE and the third UE.

In some examples, to support transmitting the indication of the conflict, the conflict indication manager 635 may be configured as or otherwise support a means for transmitting the indication of the conflict to the second UE based on the first received power being greater than the second received power.

In some examples, to support transmitting the indication of the conflict, the conflict indication manager 635 may be configured as or otherwise support a means for transmitting the indication of the conflict to the second UE based on the first received power being less than the second received power.

In some examples, the first SCI includes a first indication of a first priority associated with the second UE and the second SCI includes a second indication of a second priority associated with the third UE.

In some examples, to support transmitting the indication of the conflict, the conflict indication manager 635 may be configured as or otherwise support a means for transmitting the indication of the conflict to the second UE based on the first priority associated with the second UE being greater than the second priority associated with the third UE.

In some examples, to support transmitting the indication of the conflict, the conflict indication manager 635 may be configured as or otherwise support a means for transmitting the indication of the conflict to the second UE after the conflict has occurred based on the first priority associated with the second UE being greater than the second priority associated with the third UE.

In some examples, to support transmitting the indication of the conflict, the conflict indication manager 635 may be configured as or otherwise support a means for transmitting the indication of the conflict to the second UE based on the first priority associated with the second UE being less than the second priority associated with the third UE.

In some examples, to support transmitting the indication of the conflict, the conflict indication manager 635 may be configured as or otherwise support a means for transmitting the indication of the conflict to the second UE prior to the conflict occurring based on the first priority associated with the second UE being less than the second priority associated with the third UE.

In some examples, to support transmitting the indication of the conflict, the conflict indication manager 635 may be configured as or otherwise support a means for transmitting the indication of the conflict to the second UE or the third UE based on the first priority being equal to the second priority.

In some examples, to support transmitting the indication of the conflict, the conflict indication manager 635 may be configured as or otherwise support a means for transmitting the indication of the conflict to the second UE or the third UE based on the first priority associated with the second UE being equal to the second priority associated with the third UE and the first received power being greater than the second received power.

In some examples, the conflict indication manager 635 may be configured as or otherwise support a means for selecting the second UE to receive the indication of the conflict prior to measuring the first received power based on a priority associated with the second UE, where the indication of the conflict is transmitted to the second UE based at least is part on the selecting.

In some examples, to support measuring the first received power, the RSRP component 630 may be configured as or otherwise support a means for measuring the first received power associated with the second UE based on selecting the second UE to receive the indication of the conflict, where the indication of the conflict is transmitted to the second UE based on the first received power satisfying the condition.

Additionally, or alternatively, the communications manager 620 may support wireless communications at a second UE in accordance with examples as disclosed herein. In some examples, the control information manager 625 may be configured as or otherwise support a means for transmitting, to a first UE, SCI indicating a first set of resources for a sidelink transmission. In some examples, the conflict indication manager 635 may be configured as or otherwise support a means for receiving, from the first UE, an indication of a conflict between the first set of resources and a second set of resources associated with a third UE based on a first measured power associated with the first UE or a second measure power associated with the second UE, or both, satisfying a condition. The conflict component 640 may be configured as or otherwise support a means for transmitting the sidelink transmission using a third set of resources different from the first set of resources.

In some examples, the conflict component 640 may be configured as or otherwise support a means for transmitting the sidelink transmission using the first set of resources based on the conflict occurring prior to receiving the indication of the conflict, where the sidelink transmission using the third set of resources is a retransmission of the sidelink transmission.

In some examples, the conflict component 640 may be configured as or otherwise support a means for refraining from transmitting the sidelink transmission on the first set of resources based on the conflict occurring after receiving the indication of the conflict.

In some examples, the condition is based on a set of received power thresholds, a set of priority thresholds, a set of priorities, or any combination thereof.

In some examples, to support transmitting the SCI, the conflict indication manager 635 may be configured as or otherwise support a means for transmitting the SCI including a request for the indication of the conflict.

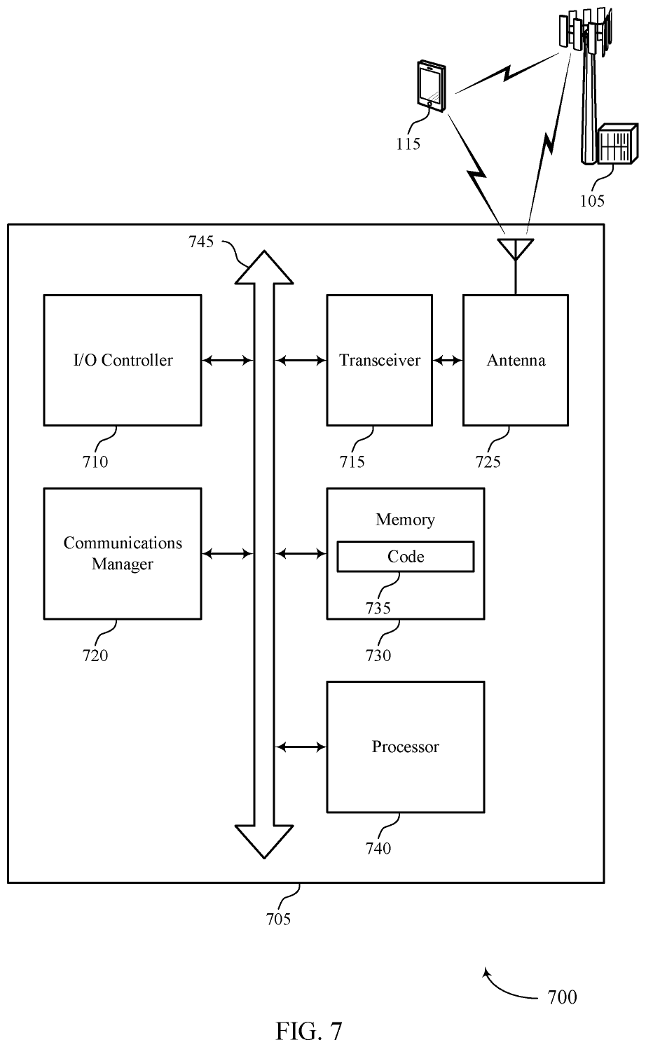

FIG. 7 shows a diagram of a system 700 including a device 705 that supports RSRP-based conflict indication for sidelink inter-UE coordination in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting RSRP-based conflict indication for sidelink inter-UE coordination). For example, the device 705 or a component of the device 705 may include a processor 740 and memory 730 coupled to the processor 740, the processor 740 and memory 730 configured to perform various functions described herein.

The communications manager 720 may support wireless communications at a first UE in accordance with examples as disclosed herein. For example, the communications manager 720 may be configured as or otherwise support a means for receiving a first SCI from a second UE and a second SCI from a third UE, the first SCI indicating a first set of resources and the second SCI indicating a second set of resources that at least partially overlap with the first set of resources. The communications manager 720 may be configured as or otherwise support a means for measuring a first received power associated with the second UE or a second received power associated with the third UE, or both, based on the second set of resources partially overlapping with the first set of resources. The communications manager 720 may be configured as or otherwise support a means for transmitting, to the second UE or the third UE, or both, an indication of a conflict based on the first received power or the second received power or both, satisfying a condition.

Additionally, or alternatively, the communications manager 720 may support wireless communications at a second UE in accordance with examples as disclosed herein. For example, the communications manager 720 may be configured as or otherwise support a means for transmitting, to a first UE, SCI indicating a first set of resources for a sidelink transmission. The communications manager 720 may be configured as or otherwise support a means for receiving, from the first UE, an indication of a conflict between the first set of resources and a second set of resources associated with a third UE based on a first measured power associated with the first UE or a second measure power associated with the second UE, or both, satisfying a condition. The communications manager 720 may be configured as or otherwise support a means for transmitting the sidelink transmission using a third set of resources different from the first set of resources.

By including or configuring the communications manager 720 in accordance with examples as described herein, the device 705 may support techniques for improved communication reliability, improved user experience related to reduced processing and reliability, more efficient utilization of communication resources, improved coordination between devices, or the like.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of RSRP-based conflict indication for sidelink inter-UE coordination as described herein, or the processor 740 and the memory 730 may be otherwise configured to perform or support such operations.

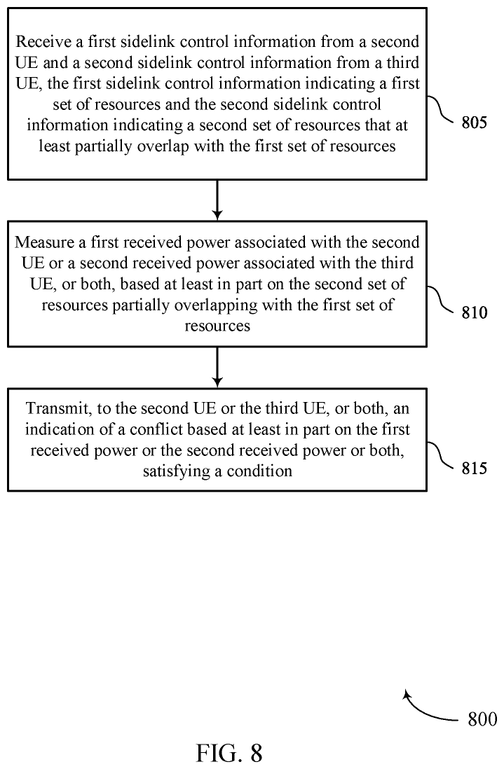

FIG. 8 shows a flowchart illustrating a method 800 that supports RSRP-based conflict indication for sidelink inter-UE coordination in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving a first SCI from a second UE and a second SCI from a third UE, the first SCI indicating a first set of resources and the second SCI indicating a second set of resources that at least partially overlap with the first set of resources. The operations of 805 may be performed in accordance with examples as disclosed herein. In some examples, aspects of the operations of 805 may be performed by a control information manager 625 as described with reference to FIG. 6.

At 810, the method may include measuring a first received power associated with the second UE or a second received power associated with the third UE, or both, based on the second set of resources partially overlapping with the first set of resources. The operations of 810 may be performed in accordance with examples as disclosed herein. In some examples, aspects of the operations of 810 may be performed by an RSRP component 630 as described with reference to FIG. 6.

At 815, the method may include transmitting, to the second UE or the third UE, or both, an indication of a conflict based on the first received power or the second received power or both, satisfying a condition. The operations of 815 may be performed in accordance with examples as disclosed herein. In some examples, aspects of the operations of 815 may be performed by a conflict indication manager 635 as described with reference to FIG. 6.

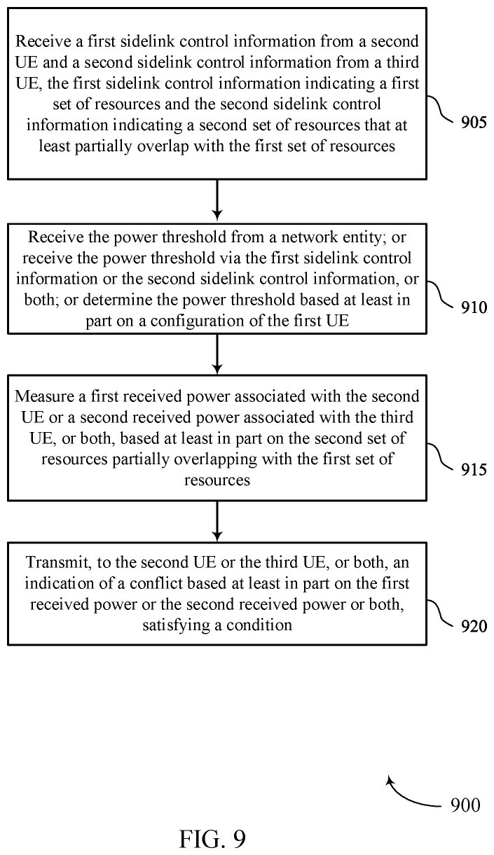

FIG. 9 shows a flowchart illustrating a method 900 that supports RSRP-based conflict indication for sidelink inter-UE coordination in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving a first SCI from a second UE and a second SCI from a third UE, the first SCI indicating a first set of resources and the second SCI indicating a second set of resources that at least partially overlap with the first set of resources. The operations of 905 may be performed in accordance with examples as disclosed herein. In some examples, aspects of the operations of 905 may be performed by a control information manager 625 as described with reference to FIG. 6.

At 910, the method may include receiving the power threshold from a network entity, via the first SCI or the second SCI, or determining the power threshold based on a configuration of the first UE. The operations of 910 may be performed in accordance with examples as disclosed herein. In some examples, aspects of the operations of 910 may be performed by a power threshold manager 645 as described with reference to FIG. 6.

At 915, the method may include measuring a first received power associated with the second UE or a second received power associated with the third UE, or both, based on the second set of resources partially overlapping with the first set of resources. The operations of 915 may be performed in accordance with examples as disclosed herein. In some examples, aspects of the operations of 915 may be performed by an RSRP component 630 as described with reference to FIG. 6.

At 920, the method may include transmitting, to the second UE or the third UE, or both, an indication of a conflict based on the first received power or the second received power or both, satisfying a condition. The operations of 920 may be performed in accordance with examples as disclosed herein. In some examples, aspects of the operations of 920 may be performed by a conflict indication manager 635 as described with reference to FIG. 6.

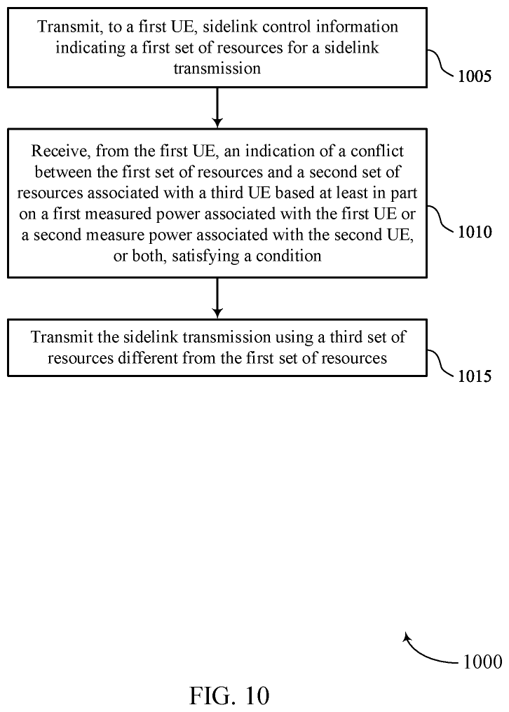

FIG. 10 shows a flowchart illustrating a method 1000 that supports RSRP-based conflict indication for sidelink inter-UE coordination in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include transmitting, to a first UE, SCI indicating a first set of resources for a sidelink transmission. The operations of 1005 may be performed in accordance with examples as disclosed herein. In some examples, aspects of the operations of 1005 may be performed by a control information manager 625 as described with reference to FIG. 6.

At 1010, the method may include receiving, from the first UE, an indication of a conflict between the first set of resources and a second set of resources associated with a third UE based on a first measured power associated with the first UE or a second measure power associated with the second UE, or both, satisfying a condition. The operations of 1010 may be performed in accordance with examples as disclosed herein. In some examples, aspects of the operations of 1010 may be performed by a conflict indication manager 635 as described with reference to FIG. 6.

At 1015, the method may include transmitting the sidelink transmission using a third set of resources different from the first set of resources. The operations of 1015 may be performed in accordance with examples as disclosed herein. In some examples, aspects of the operations of 1015 may be performed by a conflict component 640 as described with reference to FIG. 6.

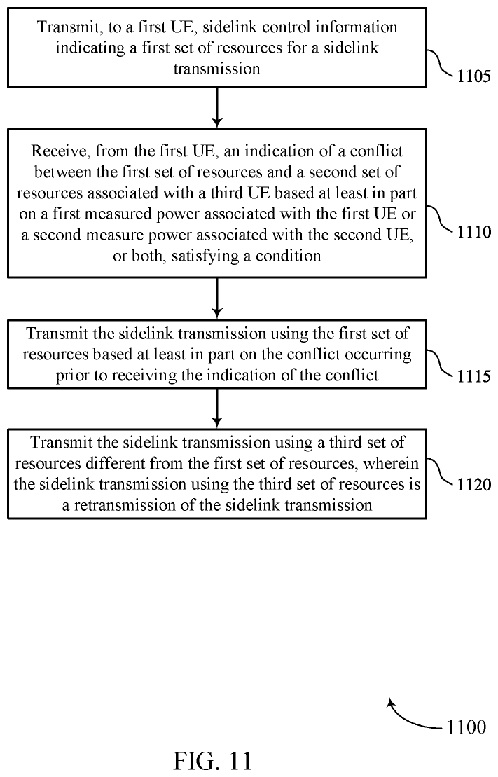

FIG. 11 shows a flowchart illustrating a method 1100 that supports RSRP-based conflict indication for sidelink inter-UE coordination in accordance with aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include transmitting, to a first UE, SCI indicating a first set of resources for a sidelink transmission. The operations of 1105 may be performed in accordance with examples as disclosed herein. In some examples, aspects of the operations of 1105 may be performed by a control information manager 625 as described with reference to FIG. 6.

At 1110, the method may include receiving, from the first UE, an indication of a conflict between the first set of resources and a second set of resources associated with a third UE based on a first measured power associated with the first UE or a second measure power associated with the second UE, or both, satisfying a condition. The operations of 1110 may be performed in accordance with examples as disclosed herein. In some examples, aspects of the operations of 1110 may be performed by a conflict indication manager 635 as described with reference to FIG. 6.

At 1115, the method may include transmitting the sidelink transmission using the first set of resources based on the conflict occurring prior to receiving the indication of the conflict. The operations of 1115 may be performed in accordance with examples as disclosed herein. In some examples, aspects of the operations of 1115 may be performed by a conflict component 640 as described with reference to FIG. 6.

At 1120, the method may include transmitting the sidelink transmission using a third set of resources different from the first set of resources, where the sidelink transmission using the third set of resources is a retransmission of the sidelink transmission. The operations of 1120 may be performed in accordance with examples as disclosed herein. In some examples, aspects of the operations of 1120 may be performed by a conflict component 640 as described with reference to FIG. 6.

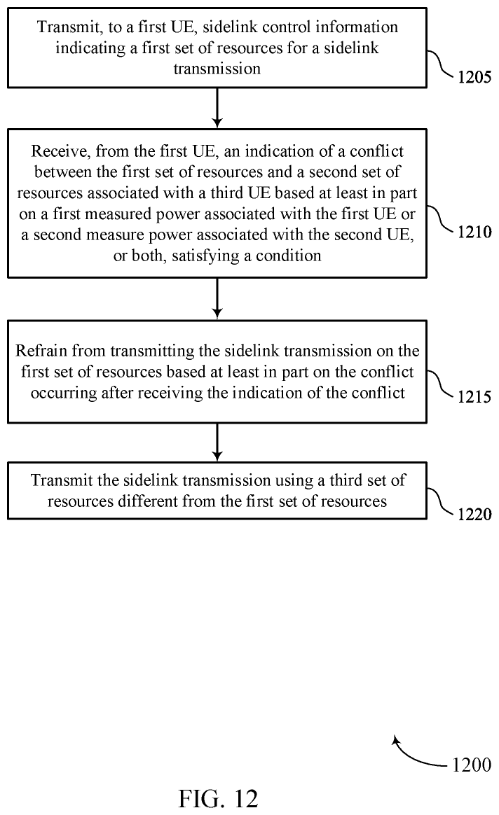

FIG. 12 shows a flowchart illustrating a method 1200 that supports RSRP-based conflict indication for sidelink inter-UE coordination in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting, to a first UE, SCI indicating a first set of resources for a sidelink transmission. The operations of 1205 may be performed in accordance with examples as disclosed herein. In some examples, aspects of the operations of 1205 may be performed by a control information manager 625 as described with reference to FIG. 6.

At 1210, the method may include receiving, from the first UE, an indication of a conflict between the first set of resources and a second set of resources associated with a third UE based on a first measured power associated with the first UE or a second measure power associated with the second UE, or both, satisfying a condition. The operations of 1210 may be performed in accordance with examples as disclosed herein. In some examples, aspects of the operations of 1210 may be performed by a conflict indication manager 635 as described with reference to FIG. 6.

At 1215, the method may include refraining from transmitting the sidelink transmission on the first set of resources based on the conflict occurring after receiving the indication of the conflict. The operations of 1215 may be performed in accordance with examples as disclosed herein. In some examples, aspects of the operations of 1215 may be performed by a conflict component 640 as described with reference to FIG. 6.

At 1220, the method may include transmitting the sidelink transmission using a third set of resources different from the first set of resources. The operations of 1220 may be performed in accordance with examples as disclosed herein. In some examples, aspects of the operations of 1220 may be performed by a conflict component 640 as described with reference to FIG. 6.

The following provides an overview of aspects of the present disclosure:
Aspect 1: A method for wireless communications at a first UE, comprising: receiving a first sidelink control information from a second UE and a second sidelink control information from a third UE, the first sidelink control information indicating a first set of resources and the second sidelink control information indicating a second set of resources that at least partially overlap with the first set of resources: measuring a first received power associated with the second UE or a second received power associated with the third UE, or both, based at least in part on the second set of resources partially overlapping with the first set of resources: and transmitting, to the second UE or the third UE, or both, an indication of a conflict based at least in part on the first received power or the second received power or both, satisfying a condition.
Aspect 2: The method of aspect 1, wherein the condition is based at least in part on a power threshold, the method further comprising: receiving the power threshold from a network entity: or receiving the power threshold via the first sidelink control information or the second sidelink control information, or both: or determining the power threshold based at least in part on a configuration of the first UE.
Aspect 3: The method of any of aspects 1 through 2, wherein the measuring comprises: measuring the first received power associated with the second UE: and measuring the second received power associated with the third UE.
Aspect 4: The method of aspect 3, further comprising: determining the condition is satisfied based at least in part on the first received power exceeding a power threshold or the second received power exceeding the power threshold, or both.
Aspect 5: The method of any of aspect 3, further comprising: determining the condition is satisfied based at least in part on the first received power being less than a power threshold or the second received power being less than the power threshold, or both.
Aspect 6: The method of any of aspects 1 through 5, wherein the condition is based at least in part on a first power threshold and a second power threshold that is greater than the first power threshold, the method further comprising: receiving the first power threshold or the second power threshold, or both, from a network entity: or receiving the first power threshold or the second power threshold, or both, via the first sidelink control information or the second sidelink control information, or both: or determining the first power threshold or the second power threshold, or both, based at least in part on a configuration of the first UE.
Aspect 7: The method of aspect 6, further comprising: determining the condition is satisfied based at least in part on the first received power or the second received power, or both, being greater than the first power threshold and less than the second power threshold.
Aspect 8: The method of any of aspects 1 through 7, wherein the condition to transmit the indication of the conflict is based at least on in part on a first priority associated with the second UE or a second priority associated with the third UE.
Aspect 9: The method of any of aspects 1 through 8, wherein the condition is further based at least in part on a priority threshold, the method further comprising: receiving the priority threshold from a network entity: or receiving the priority threshold via the first sidelink control information or the second sidelink control information, or both; or determining the priority threshold based at least in part on a configuration of the first UE.
Aspect 10: The method of aspect 9, wherein transmitting the indication of the conflict comprises: transmitting the indication of the conflict based at least in part on a first priority of the second UE satisfying the priority threshold or a second priority of the third UE satisfying the priority threshold, or both.
Aspect 11: The method of any of aspects 1 through 10, wherein the first sidelink control information or the second sidelink control information includes a request for the indication of the conflict, the indication of the conflict is transmitted based at least in part on the request.
Aspect 12: The method of any of aspects 1 through 11, wherein transmitting the indication of the conflict comprises: transmitting the indication of the conflict to the second UE and the third UE.
Aspect 13: The method of any of aspects 1 through 12, wherein transmitting the indication of the conflict comprises: transmitting the indication of the conflict to the second UE based at least in part on the first received power being greater than the second received power.
Aspect 14: The method of any of aspects 1 through 12, wherein transmitting the indication of the conflict comprises: transmitting the indication of the conflict to the second UE based at least in part on the first received power being less than the second received power.
Aspect 15: The method of any of aspects 1 through 14, wherein the first sidelink control information comprises a first indication of a first priority associated with the second UE and the second sidelink control information comprises a second indication of a second priority associated with the third UE.
Aspect 16: The method of aspect 15, wherein transmitting the indication of the conflict comprises: transmitting the indication of the conflict to the second UE based at least in part on the first priority associated with the second UE being greater than the second priority associated with the third UE.
Aspect 17: The method of aspect 16, wherein transmitting the indication of the conflict comprises: transmitting the indication of the conflict to the second UE after the conflict has occurred based at least in part on the first priority associated with the second UE being greater than the second priority associated with the third UE.
Aspect 18: The method of any of aspects 15 through 16, wherein transmitting the indication of the conflict comprises: transmitting the indication of the conflict to the second UE based at least in part on the first priority associated with the second UE being less than the second priority associated with the third UE.
Aspect 19: The method of aspect 18, wherein transmitting the indication of the conflict comprises: transmitting the indication of the conflict to the second UE prior to the conflict occurring based at least in part on the first priority associated with the second UE being less than the second priority associated with the third UE.
Aspect 20: The method of any of aspects 15 through 19, wherein transmitting the indication of the conflict comprises: transmitting the indication of the conflict to the second UE or the third UE based at least in part on the first priority being equal to the second priority.
Aspect 21: The method of any of aspects 15 through 20, wherein transmitting the indication of the conflict comprises: transmitting the indication of the conflict to the second UE or the third UE based at least in part on the first priority associated with the second UE being equal to the second priority associated with the third UE and the first received power being greater than the second received power.
Aspect 22: The method of any of aspects 1 through 21, further comprising: selecting the second UE to receive the indication of the conflict prior to measuring the first received power based at least in part on a priority associated with the second UE, wherein the indication of the conflict is transmitted to the second UE based at least is part on the selecting.
Aspect 23: The method of aspect 22, wherein measuring the first received power comprises: measuring the first received power associated with the second UE based at least in part on selecting the second UE to receive the indication of the conflict, wherein the indication of the conflict is transmitted to the second UE based at least in part on the first received power satisfying the condition.
Aspect 24: A method for wireless communications at a second UE, comprising: transmitting, to a first UE, sidelink control information indicating a first set of resources for a sidelink transmission: receiving, from the first UE, an indication of a conflict between the first set of resources and a second set of resources associated with a third UE based at least in part on a first measured power associated with the first UE or a second measure power associated with the second UE, or both, satisfying a condition: transmitting the sidelink transmission using a third set of resources different from the first set of resources.
Aspect 25: The method of aspect 24, further comprising: transmitting the sidelink transmission using the first set of resources based at least in part on the conflict occurring prior to receiving the indication of the conflict, wherein the sidelink transmission using the third set of resources is a retransmission of the sidelink transmission.
Aspect 26: The method of any of aspects 24 through 25, further comprising: refraining from transmitting the sidelink transmission on the first set of resources based at least in part on the conflict occurring after receiving the indication of the conflict.
Aspect 27: The method of any of aspects 24 through 26, wherein the condition is based at least in part on a set of received power thresholds, a set of priority thresholds, a set of priorities, or any combination thereof.
Aspect 28: The method of any of aspects 24 through 27, wherein transmitting the sidelink control information comprises: transmitting the sidelink control information including a request for the indication of the conflict.
Aspect 29: An apparatus for wireless communications at a first UE, comprising a processor: memory coupled with the processor: and instructions stored in the memory and executable by the processor to cause the apparatus to perform a method of any of aspects 1 through 23.
Aspect 30: An apparatus for wireless communications at a first UE, comprising at least one means for performing a method of any of aspects 1 through 23.
Aspect 31: A non-transitory computer-readable medium storing code for wireless communications at a first UE, the code comprising instructions executable by a processor to perform a method of any of aspects 1 through 23.
Aspect 32: An apparatus for wireless communications at a second UE, comprising a processor: memory coupled with the processor: and instructions stored in the memory and executable by the processor to cause the apparatus to perform a method of any of aspects 24 through 28.
Aspect 33: An apparatus for wireless communications at a second UE, comprising at least one means for performing a method of any of aspects 24 through 28.
Aspect 34: A non-transitory computer-readable medium storing code for wireless communications at a second UE, the code comprising instructions executable by a processor to perform a method of any of aspects 24 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first UE, comprising:
a processor;
memory coupled with the processor; and
instructions stored in the memory and executable by the processor to cause the apparatus to:
receive a first sidelink control information from a second UE and a second sidelink control information from a third UE, the first sidelink control information indicating a first set of resources and the second sidelink control information indicating a second set of resources that at least partially overlap with the first set of resources;
measure a first received power associated with the second UE or a second received power associated with the third UE, or both, based at least in part on the second set of resources partially overlapping with the first set of resources; and
transmit, to the second UE or the third UE, or both, an indication of a conflict based at least in part on the first received power or the second received power or both, satisfying a condition.

2. The apparatus of claim 1, wherein the condition is based at least in part on a power threshold, and the instructions are further executable by the processor to cause the apparatus to:
receive the power threshold from a network entity; or
receive the power threshold via the first sidelink control information or the second sidelink control information, or both; or
determine the power threshold based at least in part on a configuration of the first UE.

3. The apparatus of claim 1, wherein the instructions to measure are executable by the processor to cause the apparatus to:
measure the first received power associated with the second UE; and
measure the second received power associated with the third UE.

4. The apparatus of claim 3, wherein the instructions are further executable by the processor to cause the apparatus to:
determine the condition is satisfied based at least in part on the first received power exceeding a power threshold or the second received power exceeding the power threshold, or both.

5. The apparatus of claim 3, wherein the instructions are further executable by the processor to cause the apparatus to:
determine the condition is satisfied based at least in part on the first received power being less than a power threshold or the second received power being less than the power threshold, or both.

6. The apparatus of claim 1, wherein the condition is based at least in part on a first power threshold and a second power threshold that is greater than the first power threshold, and the instructions are further executable by the processor to cause the apparatus to:
receive the first power threshold or the second power threshold, or both, from a network entity; or
receive the first power threshold or the second power threshold, or both, via the first sidelink control information or the second sidelink control information, or both; or
determine the first power threshold or the second power threshold, or both, based at least in part on a configuration of the first UE. 10

7. The apparatus of claim 6, wherein the instructions are further executable by the processor to cause the apparatus to:
determine the condition is satisfied based at least in part on the first received power or the second received power, or both, being greater than the first power threshold and less than the second power threshold.

8. The apparatus of claim 1, wherein the condition to transmit the indication of the conflict is based at least on in part on a first priority associated with the second UE or a second priority associated with the third UE.

9. The apparatus of claim 1, wherein the condition is further based at least in part on a priority threshold, and the instructions are further executable by the processor to cause the apparatus to:
receive the priority threshold from a network entity; or
receive the priority threshold via the first sidelink control information or the second sidelink control information, or both; or
determine the priority threshold based at least in part on a configuration of the first UE.

10. The apparatus of claim 9, wherein the instructions to transmit the indication of the conflict are executable by the processor to cause the apparatus to:
transmit the indication of the conflict based at least in part on a first priority of the second UE satisfying the priority threshold or a second priority of the third UE satisfying the priority threshold, or both.

11. The apparatus of claim 1, wherein:
the first sidelink control information or the second sidelink control information includes a request for the indication of the conflict,
the indication of the conflict is transmitted based at least in part on the request.

12. The apparatus of claim 1, wherein the instructions to transmit the indication of the conflict are executable by the processor to cause the apparatus to:
transmit the indication of the conflict to the second UE and the third UE.

13. The apparatus of claim 1, wherein the instructions to transmit the indication of the conflict are executable by the processor to cause the apparatus to:
transmit the indication of the conflict to the second UE based at least in part on the first received power being greater than the second received power.

14. The apparatus of claim 1, wherein the instructions to transmit the indication of the conflict are executable by the processor to cause the apparatus to:
transmit the indication of the conflict to the second UE based at least in part on the first received power being less than the second received power.

15. The apparatus of claim 1, wherein the first sidelink control information comprises a first indication of a first priority associated with the second UE and the second sidelink control information comprises a second indication of a second priority associated with the third UE.

16. The apparatus of claim 15, wherein the instructions to transmit the indication of the conflict are executable by the processor to cause the apparatus to:
transmit the indication of the conflict to the second UE based at least in part on the first priority associated with the second UE being greater than the second priority associated with the third UE.

17. The apparatus of claim 16, wherein the instructions to transmit the indication of the conflict are executable by the processor to cause the apparatus to:
transmit the indication of the conflict to the second UE after the conflict has occurred based at least in part on the first priority associated with the second UE being greater than the second priority associated with the third UE.

18. The apparatus of claim 15, wherein the instructions to transmit the indication of the conflict are executable by the processor to cause the apparatus to:
transmit the indication of the conflict to the second UE, wherein the first priority associated with the second UE being less than the second priority associated with the third UE.

19. The apparatus of claim 18, wherein the instructions to transmit the indication of the conflict are executable by the processor to cause the apparatus to:
transmit the indication of the conflict to the second UE prior to the conflict occurring based at least in part on the first priority associated with the second UE being less than the second priority associated with the third UE.

20. The apparatus of claim 15, wherein the instructions to transmit the indication of the conflict are executable by the processor to cause the apparatus to:
transmit the indication of the conflict to the second UE or the third UE based at least in part on the first priority being equal to the second priority.

21. The apparatus of claim 15, wherein the instructions to transmit the indication of the conflict are executable by the processor to cause the apparatus to:
transmit the indication of the conflict to the second UE or the third UE based at least in part on the first priority associated with the second UE being equal to the second priority associated with the third UE and the first received power being greater than the second received power.

22. The apparatus of claim 1, wherein the instructions are further executable by the processor to cause the apparatus to:
select the second UE to receive the indication of the conflict prior to measuring the first received power based at least in part on a priority associated with the second UE, wherein the indication of the conflict is transmitted to the second UE based at least is part on the selecting.

23. The apparatus of claim 22, wherein the instructions to measure the first received power are executable by the processor to cause the apparatus to:
measure the first received power associated with the second UE based at least in part on selecting the second UE to receive the indication of the conflict, wherein the indication of the conflict is transmitted to the second UE based at least in part on the first received power satisfying the condition.

24. An apparatus for wireless communications at a second UE, comprising:
a processor;
memory coupled with the processor; and
instructions stored in the memory and executable by the processor to cause the apparatus to:
transmit, to a first UE, sidelink control information indicating a first set of resources for a sidelink transmission;
receive, from the first UE, an indication of a conflict between the first set of resources and a second set of resources associated with a third UE based at least in part on a first measured power associated with the first UE or a second measure power associated with the second UE, or both, satisfying a condition;
transmit the sidelink transmission using a third set of resources different from the first set of resources.

25. The apparatus of claim 24, wherein the instructions are further executable by the processor to cause the apparatus to:
transmit the sidelink transmission using the first set of resources based at least in part on the conflict occurring prior to receiving the indication of the conflict, wherein the sidelink transmission using the third set of resources is a retransmission of the sidelink transmission.

26. The apparatus of claim 24, wherein the instructions are further executable by the processor to cause the apparatus to:
refrain from transmitting the sidelink transmission on the first set of resources based at least in part on the conflict occurring after receiving the indication of the conflict.

27. The apparatus of claim 24, wherein the condition is based at least in part on a set of received power thresholds, a set of priority thresholds, a set of priorities, or any combination thereof.

28. The apparatus of claim 24, wherein the instructions to transmit the sidelink control information are executable by the processor to cause the apparatus to:
transmit the sidelink control information including a request for the indication of the conflict.

29. A method for wireless communications at a first UE, comprising:
receiving a first sidelink control information from a second UE and a second sidelink control information from a third UE, the first sidelink control information indicating a first set of resources and the second sidelink control information indicating a second set of resources that at least partially overlap with the first set of resources;
measuring a first received power associated with the second UE or a second received power associated with the third UE, or both, based at least in part on the second set of resources partially overlapping with the first set of resources; and
transmitting, to the second UE or the third UE, or both, an indication of a conflict based at least in part on the first received power or the second received power or both, satisfying a condition.

30. A method for wireless communications at a second UE, comprising:
transmitting, to a first UE, sidelink control information indicating a first set of resources for a sidelink transmission;
receiving, from the first UE, an indication of a conflict between the first set of resources and a second set of resources associated with a third UE based at least in part on a first measured power associated with the first UE or a second measure power associated with the second UE, or both, satisfying a condition;
transmitting the sidelink transmission using a third set of resources different from the first set of resources.
